(19) United States
(12) Patent Application Publication
(10) Pub. No.: US 2025/0341289 A1
(43) Pub. Date: Nov. 6, 2025

(54) METHODS AND INTERNET OF THINGS (IOT) SYSTEMS FOR ACQUIRING PIPELINE SIGNALS FOR SMART GAS MONITORING

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN); Jun WANG, Chengdu (CN); Hongjian LIU, Chengdu (CN)

(73) Assignee: CHENGDU QINCHUAN IOT TECHNOLOGY CO., LTD., Chengdu (CN)

(21) Appl. No.: 19/270,457

(22) Filed: Jul. 15, 2025

(30) Foreign Application Priority Data
May 22, 2025 (CN) 202510660419.8

(51) Int. Cl. F17D 5/00; F17D 5/06

(52) U.S. Cl. CPC F17D 5/005; F17D 5/06

(57) ABSTRACT

A method and an IoT system for acquiring pipeline signals for smart gas monitoring are provided, and the method is executed by a gas company management platform of the IoT system. The method includes obtaining acquisition device information of a plurality of signal acquisition devices in a gas pipeline network, determining a device to be activated based on a signal acquisition requirement and the acquisition device information, generating an activation instruction based on the device to be activated, determining a signal acquisition parameter based on the signal acquisition requirement, controlling the activated acquisition device and the operating acquisition device to perform signal acquisition based on the signal acquisition parameter to obtain a gas pipeline network signal, in response to an activation failure of the device to be activated, determining an alternative acquisition device based on the acquisition device information, generating an alternate device instruction based on the alternative acquisition device.

### CROSS-REFERENCE TO RELATED APPLICATIONS

This application claims priority to Chinese Patent Application No. 202510660419.8, filed on May 22, 2025, the entire contents of which are hereby incorporated by reference.

### TECHNICAL FIELD

The present disclosure relates to the field of gas pipeline network monitoring, and in particular, to methods and Internet of Things (IoT) systems for acquiring pipeline signals for smart gas monitoring.

### BACKGROUND

To achieve comprehensive and efficient monitoring of the gas pipeline network, signal acquisition devices need to be deployed at different locations in the network. Supervisors may determine the operating status of the gas pipeline network through the signals acquired by the signal acquisition devices at different locations. However, due to the vast scale and complexity of the pipeline network, the supervisors need to monitor different pipeline network areas separately. The key challenges currently being addressed include determining the signal acquisition device that may accurately acquire the required signals and adjusting signal acquisition parameters according to the requirement.

Therefore, it is desired to provide a method and an IoT system for acquiring pipeline signals for smart gas monitoring, which quickly and intelligently determines the signal acquisition devices to be activated and adjusts signal acquisition parameters based on the signal acquisition requirement.

### SUMMARY

One or more embodiments of the present disclosure provide a method for acquiring pipeline signals for smart gas monitoring. The method may include obtaining acquisition device information of a plurality of signal acquisition devices in a gas pipeline network, the plurality of signal acquisition devices including a dormant acquisition device and an operating acquisition device; determining a device to be activated based on a signal acquisition requirement and the acquisition device information; generating an activation instruction based on the device to be activated and sending the activation instruction to a device object platform through a gas company sensor network platform to activate the device to be activated to obtain an activated acquisition device; determining a signal acquisition parameter based on the signal acquisition requirement; sending the signal acquisition parameter to the device object platform through the gas company sensor network platform to control the activated acquisition device and the operating acquisition device to perform signal acquisition based on the signal acquisition parameter to obtain a gas pipeline network signal; in response to an activation failure of the device to be activated, determining an alternative acquisition device based on the acquisition device information; and generating an alternate device instruction based on the alternative acquisition device and sending the alternate device instruction to the device object platform through the gas company sensor network platform to control the alternative acquisition device for signal acquisition.

One or more embodiments of the present disclosure provide an IoT system for acquiring pipeline signals for smart gas monitoring. The IoT system may include a government safety monitoring and management platform, a government safety monitoring sensor network platform, a government safety monitoring object platform, a gas company sensor network platform, and a device object platform. The government safety monitoring object platform may include a gas company management platform. The gas company management platform may be configured on a server of a gas company, the gas company sensor network platform may include a plurality of distributed communication devices, the device object platform may be communicatively connected to a plurality of signal acquisition devices, and the government safety monitoring sensor network platform and the government safety monitoring and management platform may be configured on a server of a government monitoring department. The gas company management platform may be configured to obtain acquisition device information of a plurality of signal acquisition devices in a gas pipeline network, the plurality of signal acquisition devices including a dormant acquisition device and an operating acquisition device; determine a device to be activated based on a signal acquisition requirement and the acquisition device information; generate an activation instruction based on the device to be activated and send the activation instruction to the device object platform through the gas company sensor network platform to activate the device to be activated to obtain an activated acquisition device; determine a signal acquisition parameter based on the signal acquisition requirement; send the signal acquisition parameter to the device object platform through the gas company sensor network platform to control the activated acquisition device and the operating acquisition device to perform signal acquisition based on the signal acquisition parameter to obtain a gas pipeline network signal; in response to an activation failure of the device to be activated, determine an alternative acquisition device based on the acquisition device information; and generate an alternate device instruction based on the alternative acquisition device and send the alternate device instruction to the device object platform through the gas company sensor network platform to control the alternative acquisition device for signal acquisition.

One or more embodiments of the present disclosure provide a non-transitory computer-readable storage medium storing computer instructions. When the computer reads the computer instructions in the storage medium, the computer may perform the aforementioned method.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an IoT system for acquiring pipeline signals for smart gas monitoring according to some embodiments of the present disclosure;

FIG. 2 is a flowchart illustrating an exemplary method for acquiring pipeline signals for smart gas monitoring according to some embodiments of the present disclosure;

FIG. 3 is a schematic diagram illustrating an exemplary acquisition model according to some embodiments of the present disclosure; and

FIG. 4 is a flowchart illustrating an exemplary process for updating a signal acquisition parameter according to some embodiments of the present disclosure.

### DETAILED DESCRIPTION

To more clearly illustrate the technical solutions related to the embodiments of the present disclosure, a brief introduction of the drawings referred to the description of the embodiments is provided below. The accompanying drawings do not represent the entirety of the embodiments.

It should be understood that “system”, “device”, “unit” and/or “module” as used herein is a manner used to distinguish different components, elements, parts, sections, or assemblies at different levels. However, if other words serve the same purpose, the words may be replaced by other expressions.

When describing the operations performed in the embodiments of the present disclosure in terms of the steps, the order of the operations is all interchangeable if not otherwise specified, the operations are omittable, and other operations may be included in the process.

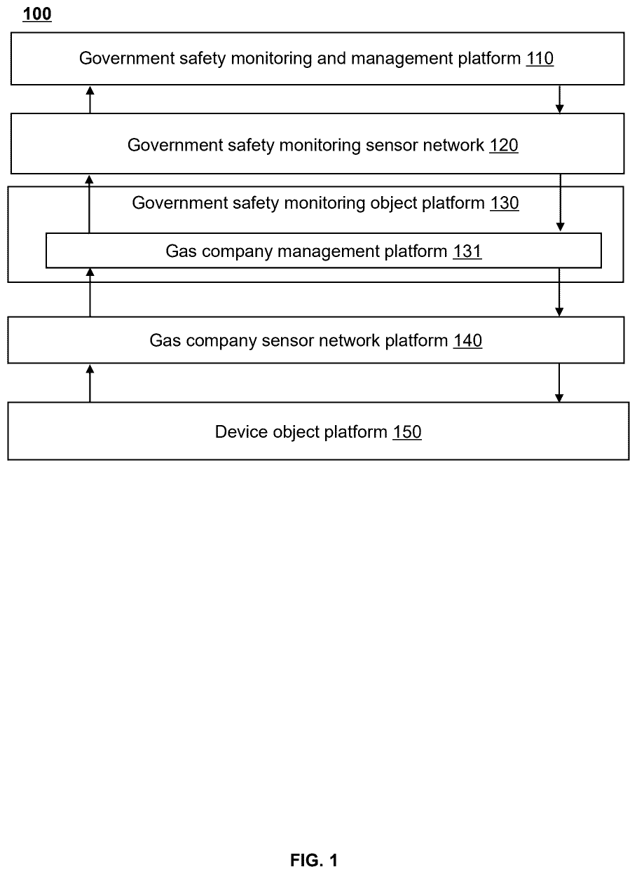

FIG. 1 is a schematic diagram illustrating an IoT system for acquiring pipeline signals for smart gas monitoring according to some embodiments of the present disclosure.

As shown in FIG. 1, the IoT system 100 for acquiring pipeline signals for smart gas monitoring may include a government safety monitoring and management platform 110, a government safety monitoring sensor network platform 120, a government safety monitoring object platform 130, a gas company sensor network platform 140, and a device object platform 150.

The government safety monitoring and management platform 110 refers to an integrated management platform for government management information. In some embodiments, the government safety monitoring and management platform is configured on a server of a government monitoring department. The government safety monitoring and management platform is configured to process a gas pipeline network signal to generate feedback information.

The government safety monitoring sensor network platform 120 refers to a platform used for the integrated management of sensed information by the government. In some embodiments, the government safety monitoring sensor network platform is configured as a distributed communication device (e.g., a communications network, a gateway, etc.), etc.

The government safety monitoring object platform 130 refers to a platform for generating monitoring information and executing control information of the government. In some embodiments, the government safety monitoring object platform 130 includes a gas company management platform 131. The gas company management platform 131 refers to a comprehensive management platform for gas company information. The gas company management platform is configured on a server of a gas company. The server of the gas company includes a processor, a memory, etc. The gas company management platform is configured to process and store data from the IoT system 100 for acquiring pipeline signals for smart gas monitoring.

In some embodiments, the gas company management platform 131 is configured to obtain acquisition device information of a plurality of signal acquisition devices in a gas pipeline network, determine a device to be activated based on a signal acquisition requirement and the acquisition device information, generate an activation instruction based on the device to be activated, determine a signal acquisition parameter based on the signal acquisition requirement; control the activated acquisition device and an operating acquisition device to perform signal acquisition based on the signal acquisition parameter to obtain a gas pipeline network signal, in response to an activation failure of the device to be activated, determine an alternative acquisition device based on the acquisition device information, and generate an alternate device instruction based on the alternative acquisition device.

In some embodiments, the gas company management platform interacts with the government safety monitoring sensor network platform and the gas company sensor network platform.

The gas company sensor network platform 140 refers to a platform that integrates and manages the sensed information of the gas company. In some embodiments, the gas company sensor network platform is configured as a plurality of distributed communication devices (e.g., communication networks, gateways, etc.). In some embodiments, the gas company sensor network platform interacts with the device object platform.

The device object platform 150 refers to a functional platform for generating sensor information and executing control information. In some embodiments, the device object platform 150 includes a plurality of signal acquisition devices.

The signal acquisition devices refer to devices that acquire the gas pipeline network signal. In some embodiments, the signal acquisition devices include a pressure sensor, a flow meter, a flow rate meter, a temperature sensor, an ultrasonic detector, etc. The signal acquisition devices are deployed inside or outside of the gas pipeline.

The gas pipeline network signal refers to data related to the operational state of the gas pipeline network, for example, gas pressure, gas flow rate, gas flow rate, gas temperature, pipeline impurity deposition thickness, etc. The pipeline impurity deposition thickness is obtained by the ultrasonic detector. The gas pipeline network refers to a gas transmission network consisting of a plurality of gas pipelines and gas transportation-related devices.

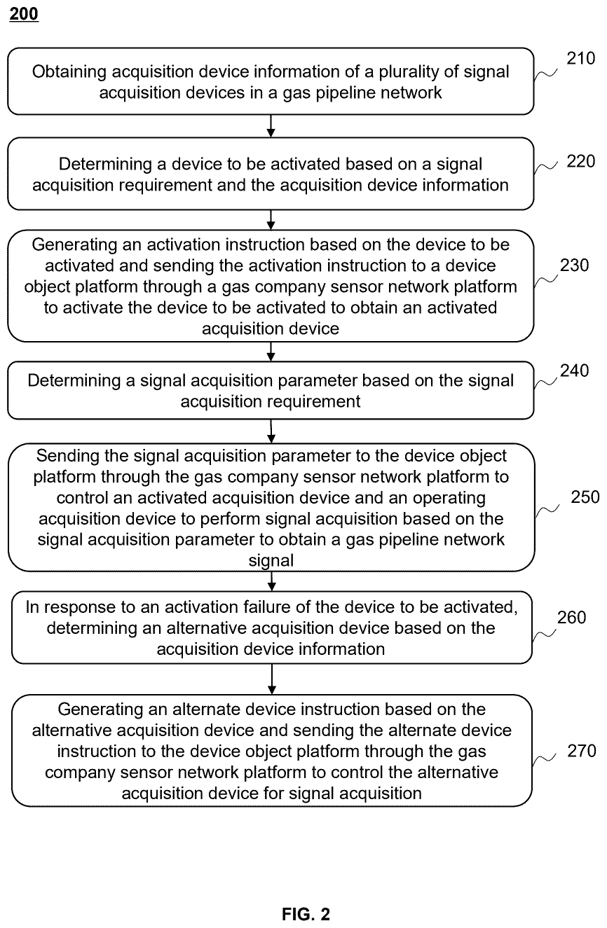

More descriptions regarding the foregoing may be found in FIG. 2-FIG. 4 and related descriptions.

In some embodiments, based on the IoT system 100 for acquiring pipeline signals for smart gas monitoring, a closed loop of information operation between various functional platforms may be formed, various functional platforms may coordinate and operate regularly, thereby realizing the informatization and intelligence of intelligent gas pipeline network signal acquisition.

FIG. 2 is a flowchart illustrating an exemplary method for acquiring pipeline signals for smart gas monitoring according to some embodiments of the present disclosure. In some embodiments, the process 200 is performed by the gas company management platform (hereinafter referred to as the company management platform) of a method for acquiring pipeline signals for smart gas monitoring.

As shown in FIG. 2, process 200 includes the following operations.

In 210, acquisition device information of a plurality of signal acquisition devices in a gas pipeline network are obtained.

In some embodiments, the plurality of signal acquisition devices are classified into a dormant acquisition device and an operating acquisition device based on an operational state. The operating acquisition device refers to a signal acquisition device that is in a running state. The dormant acquisition device refers to a signal acquisition device that is not activated for operation. The company management platform may periodically send a feedback instruction to the signal acquisition devices and receive the feedback information from the signal acquisition devices, determine the operational state of the signal acquisition devices that sends the feedback information to be in operation, and determine the operational state of the signal acquisition devices that does not send the feedback information as not activated for operation.

More descriptions regarding the signal acquisition devices may be found in FIG. 1 and relevant descriptions.

The acquisition device information refers to information related to the signal acquisition devices, such as the number and location of the signal acquisition devices, the type of the gas pipeline network signal, etc. In some embodiments, the type of the gas pipeline network signal refers to the type of the gas pipeline network signal that the signal acquisition devices used to acquire. For example, the type of the gas pipeline network signal captured by the pressure sensor is gas pressure.

In some embodiments, the company management platform may obtain the acquisition device information from the memory of a server of the gas company. After installing the signal acquisition devices, the acquisition device information may be uploaded to the IoT system 100 by entry, etc., and stored in the memory of the server of the gas company.

In 220, a device to be activated is determined based on a signal acquisition requirement and the acquisition device information.

The signal acquisition requirement refers to the requirement for acquiring the gas pipeline network signal to perform work related to gas pipeline network monitoring. In some embodiments, the signal acquisition requirement includes at least one of a pipeline inspection requirement, a gas monitoring requirement, a hidden danger detection requirement, a gas regulation requirement, a pipeline cleaning requirement, a pipeline renewal requirement, etc. The signal acquisition requirement also includes an area location. The regional location refers to an area of the gas pipeline network where the gas pipeline network signal needs to be acquired.

In some embodiments, the signal acquisition requirement is automatically generated by the company management platform at regular intervals to satisfy regular monitoring of the gas pipeline network. The company management platform may also obtain the signal acquisition requirement through a government safety monitoring and management platform via a government safety monitoring sensor network platform. The supervisors of the government safety monitoring and management platform issue the signal acquisition requirement based on actual needs.

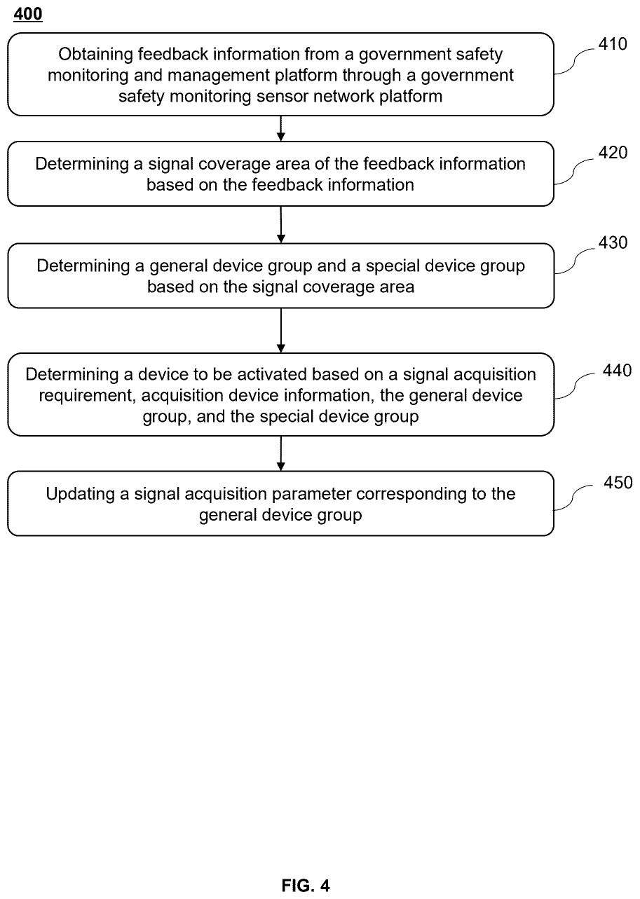

In some embodiments, the company management platform may generate the signal acquisition requirement based on the feedback information. For example, when the feedback information includes pipeline network cleanup information, the company management platform may generate a pipeline cleanup requirement as the signal acquisition requirement based on the gas pipeline or area to be cleaned in the pipeline network renovation information. More descriptions regarding the feedback information may be found in FIG. 4 and relevant descriptions.

The device to be activated refers to a dormant acquisition device that needs to be activated. Understandably, the dormant acquisition device needs to be activated to acquire the gas pipeline network signal to satisfy the signal acquisition requirement when the operating acquisition device is unable to satisfy the signal acquisition requirement.

In some embodiments, the company management platform, based on the signal acquisition requirement, queries the type of the gas pipeline network signal corresponding to the signal acquisition requirement in an acquisition requirement table, and determine, based on the acquisition device information and the area location in the signal acquisition requirement, the dormant acquisition device used for acquisition of that type of the gas pipeline network signal within the area location as the device to be activated. Exemplarily, if the signal acquisition requirement is a pipeline cleaning requirement, the type of the gas pipeline network signal corresponding to the pipeline cleaning requirement in the acquisition requirement table includes a pipeline impurity deposition thickness.

More descriptions regarding the acquisition requirement table may be found in operation 240 and the relevant descriptions.

In 230, an activation instruction is generated based on the device to be activated and the activation instruction is sent to a device object platform through a gas company sensor network platform to activate the device to be activated to obtain an activated acquisition device.

The activation instruction refers to an instruction for activating the device to be activated. In some embodiments, the company management platform determines the number of the device to be activated based on the acquisition device information of the device to be activated and generates the activation instruction based on the number.

The activated acquisition device refers to the device to be activated after activation.

In some embodiments, the company management platform may send the activation instruction to the device to be activated of the device object platform via the gas company sensor network platform to activate the device to be activated.

In 240, a signal acquisition parameter is determined based on the signal acquisition requirement.

The signal acquisition parameter refers to a parameter related to the operation of the signal acquisition devices. In some embodiments, the signal acquisition parameter includes a signal type, an acquisition time, an acquisition period, an acquisition amount, etc. In some embodiments, the signal type refers to a type of the gas pipeline network signal that may be acquired. The acquisition amount refers to the amount of data that needs to be acquired for the gas pipeline network signal. In some embodiments, the acquisition amount may be represented by the amount of space in the memory occupied by the acquired gas pipeline network signal.

In some embodiments, the company management platform determines the signal acquisition parameter based on the signal acquisition requirement in a plurality of manners. For example, the acquisition requirement table also includes the signal acquisition parameter corresponding to the signal acquisition requirement, and the company management platform, based on the signal acquisition requirement, determines the signal acquisition parameter obtained as the current signal acquisition parameter by querying the signal acquisition parameter corresponding to the signal acquisition requirement in the acquisition requirement table.

In some embodiments, the acquisition requirement table is pre-set by a technician based on historical acquisition records. For example, for each signal acquisition requirement, the technician filters a plurality of gas pipeline network signals acquired in the historical acquisition records to obtain a plurality of gas pipeline network signals of the same type that may satisfy the signal acquisition requirement, statistically counts the average value of signal acquisition parameters of the plurality of gas pipeline network signals, and constructs the acquisition requirement table based on the signal acquisition requirement, the type of the gas pipeline network signal that may satisfy the signal acquisition requirement, and the average value of the signal acquisition parameters corresponding to the plurality of gas pipeline network signal. In some embodiments, the historical acquisition record refers to a record of acquiring the gas pipeline network signal at a past time. The company management platform may access the historical acquisition records through the memory.

Because there may be a plurality of gas pipeline network signals that may satisfy the signal acquisition requirement, each signal acquisition requirement in the acquisition requirement table may correspond to a plurality of types of gas pipeline network signals and the signal acquisition parameter corresponding to each type.

In some embodiments, the company management platform determines at least one acquisition device group based on the acquisition device information, the signal acquisition requirement, the activated acquisition device, and the operating acquisition device, and determines a signal acquisition parameter corresponding to the at least one acquisition device group based on the signal acquisition requirement and the acquisition device information.

The acquisition device group refers to a combination formed by a plurality of signal acquisition devices. In some embodiments, one acquisition device group corresponds to one signal acquisition requirement.

In some embodiments, the company management platform may determine the acquisition device group in a plurality of manners. For example, the company management platform determines a signal acquisition parameter for the activating the acquisition device and a signal acquisition parameter for operating the acquisition device based on the signal acquisition requirement through the acquisition requirement table, dividing the plurality of signal acquisition devices based on a importance level, a location in the acquisition device information, and a signal type, an acquisition time, an acquisition period, and the acquisition amount in the signal acquisition parameter to obtain the at least one acquisition device group.

In some embodiments, dividing the plurality of signal acquisition devices includes determining a target acquisition device based on the original acquisition parameter and the current signal acquisition parameter, and performing cluster analysis based on the location of the target acquisition device, the original acquisition parameter, and the importance level to obtain at the least one acquisition device group. The importance level of the signal acquisition devices may be predetermined by the staff of the gas company. In some embodiments, the target acquisition device refers to a signal acquisition device whose original acquisition parameter is identical to the current signal acquisition parameter. The original acquisition parameter refers to a signal acquisition parameter used by the signal acquisition devices in the past. The current signal acquisition parameter refers to a signal acquisition parameter determined by the acquisition requirement table. The company management platform may access the original acquisition parameter from the memory.

In some embodiments, the importance level of the signal acquisition devices may also be determined based on the pipeline level in which the signal acquisition devices are located (e.g., a main pipeline, a primary branch, a secondary branch, etc.). The higher the pipeline level, the higher the importance level. The importance level may be expressed as a numeric value, and the higher the value, the higher the importance level.

In some embodiments, the clustering analysis may include K-means clustering, hierarchical clustering, etc. K-means clustering is presented herein as an example. Determining the at least one acquisition device group by K-means clustering may include the following operations.

In S11, a count of signal acquisition parameters queried through the acquisition requirement table is a count of clusters k.

In S12, a parameter vector is constructed based on the location, the original acquisition parameter, and the importance level of each target acquisition device, where the parameter vector is a feature vector constructed based on the location, the original acquisition parameter, and the importance level, and each target acquisition device corresponds to a parameter vector.

In S13, k target acquisition devices among a plurality of target acquisition devices is arbitrarily formulated as initial clustering centers.

In S14, a vector distance between the parameter vector of each target acquisition device and the parameter vector of an initial clustering center is calculated, and the target acquisition device is assigned to the cluster where the initial clustering center with the closest vector distance is located.

In S15, for each clustering cluster, the average value of the eigenvectors of the plurality of the target acquisition devices therein is calculated and designated as the center of a new clustering.

In S16, operations S14˜S15 are repeated until the clustering center is no longer changed, and the final cluster is obtained.

In S17, each final clustering cluster is treated as an acquisition device group.

In some embodiments, the company management platform determines a similarity between the plurality of signal acquisition devices based on the acquisition device information and historical feedback information, and determines the at least one acquisition device group based on the similarity and the signal acquisition requirement. The historical feedback information refers to feedback information in historical data. The company management platform may access the historical feedback information from the memory. More descriptions regarding the feedback information may be found below, and relevant descriptions.

The similarity refers to a degree of similarity between signal acquisition devices. In some embodiments, the similarity includes a location similarity and an environment similarity of the signal acquisition devices, etc.

The location similarity refers to a similarity that characterizes the existence of the abnormal situation at the location of the signal acquisition devices. The abnormal situation includes the occurrence of malfunctions or the occurrence of hidden dangers, etc.

In some embodiments, the location similarity may be determined based on the historical feedback information in historical data. For example, the company management platform may obtain a count of times the abnormal situation exists at the location of the signal acquisition devices from the historical feedback information. If the count of times of occurrence of malfunctions or hidden dangers corresponding to any two signal acquisition devices exceeds a predetermined count threshold, then the location similarity between the two signal acquisition devices is set to 1. If the count of times of occurrence of malfunctions or hidden dangers corresponding to at least one signal acquisition device of any two signal acquisition devices does not exceed the predetermined count threshold, the location similarity between the two is calculated by a predetermined similarity equation. In some embodiments, the location of the signal acquisition devices is determined based on the acquisition device information. Exemplarily, the predetermined similarity formula is shown in equation (1):

$${S}_{l} = \frac{a + b - \vert a - b \vert}{a + b} \qquad ( 1 )$$

Sₗ denotes the location similarity between the two signal acquisition devices, a denotes a count of times the abnormal situation exists at the location of one signal acquisition device, and b denotes a count of times the abnormal situation exists at the location of the other signal acquisition device. In some embodiments, if either of the two signal acquisition devices exceeds the predetermined count threshold, the predetermined count threshold is taken as its value. The predetermined count threshold is predetermined based on historical experience.

The environment similarity refers to a similarity of the environmental situation at the location of the signal acquisition device. The environmental situation includes temperature, humidity, traffic flow, etc. In the embodiments, the traffic flow may be accessed through third-party platforms or traffic monitoring.

In some embodiments, the environment similarity is determined computationally based on an actual environmental situation at the location of the signal acquisition devices. For example, the company management platform calculates a temperature similarity, a humidity similarity, and a gas flow rate similarity, respectively, for any two signal acquisition devices, and takes the average value of the temperature similarity, the humidity similarity, and the gas flow rate similarity as the environment similarity. In the embodiments, the calculation of the temperature similarity, the humidity similarity, and the gas flow rate similarity is similar to the calculation of the location similarity.

In some embodiments, the company management platform may also determine similarity between the signal acquisition devices through a similarity model.

The similarity model refers to a model used to determine the similarity between signal acquisition devices. In some embodiments, the similarity model refers to a machine learning model, such as a recurrent neural network model (RNN, Recurrent Neural Network), etc.

In some embodiments, inputs to the similarity model include the acquisition device information, the location similarity, the environment similarity, and a second device group of two signal acquisition devices, and outputs include the similarity. The second device group includes a general device group and a special device group. More descriptions regarding the general device group and the special device group may be found in FIG. 4 and the relevant descriptions.

In some embodiments, the similarity model may be obtained by training with a similarity training set. The similarity training set includes a large count of similarity samples with a similarity label. The similarity samples may include sample acquisition device information, a sample location similarity, a sample environment similarity, and a sample second device group of two sample signal acquisition devices. The similarity label includes a similarity calculated based on the similarity samples.

In some embodiments, the similarity samples may be obtained based on historical collection records. The similarity label may be determined based on whether historical gas pipeline network signals captured by a historical acquisition device group in the historical acquisition records meet a historical signal acquisition requirement. For example, if the historical gas pipeline network signals meet the historical signal acquisition requirement, the company management platform may set the similarity label between any two historical signal acquisition devices in the corresponding historical acquisition device group to 1. If the historical signal acquisition requirement is not met, the similarity label is calculated following the predetermined labeling equation. Exemplarily, the predetermined labeling equation is shown in equation (2):

$$S = 1 - \frac{n}{N} \qquad ( 2 )$$

S denotes the similarity label, n denotes the sum of the count of misclassifications of the historical feedback information and the count of adjustments of the signal acquisition parameter by the company management platform based on the historical feedback information after the historical gas pipeline network signals fail to satisfy the historical signal acquisition requirement, and N denotes the total count of historical acquisitions. In the embodiments, the total count of historical acquisitions refers to the total count of times that the historical acquisition device group acquires historical gas pipeline network signals in response to the historical signal acquisition requirement. Whether it is possible to meet the historical signal acquisition requirement is manually marked by the technician according to the actual situation. For example, if the historical gas pipeline network signals acquired by the historical acquisition device group result in a misjudgment of the historical feedback information, it is not possible to satisfy the historical signal acquisition requirement.

The misjudgment refers to the generation of erroneous historical feedback information based on historical gas pipeline network signals by the company management platform. Adjustment of the signal acquisition parameter by the company management platform based on the feedback information may be found in FIG. 4 and its related description.

The similarity model may be trained in the following way. The similarity training set is input into the initial similarity model, the loss function is constructed based on the similarity label and the output of the initial similarity model, the initial acquisition model is updated based on the iteration of the loss function, and the similarity model training is completed when the loss function meets predetermined iteration conditions. In the embodiments, the predetermined iteration conditions may be that the loss function converges, the count of iterations reaches a set value, etc.

In some embodiments, the company management platform determines a plurality of preparatory groups based on the similarity between signal acquisition devices, and determines the at least one acquisition device group based on the preparatory groups. The preparatory group refers to a set of a plurality of similar signal acquisition devices.

In some embodiments, the company management platform may determine the plurality of preparatory groups based on the similarity through clustering to enable signal acquisition devices with higher similarity to be classified into the same preparatory group. The clustering is performed similarly to the process described in operations S11-S17, and it is only necessary to change the calculation of the vector distance to the calculation of similarity in operation S14 to assign signal acquisition devices to the clusters that are the most similar to them.

In some embodiments, the company management platform may select, among the plurality of preparatory groups, a plurality of preparatory groups within an area location corresponding to a type of desired gas pipeline network signal, and select a predetermined count of signal acquisition devices to form the acquisition device group. The predetermined count may be predetermined based on historical experience. In the embodiments, the type of the desired gas pipeline network signal refers to the type of the gas pipeline network signal corresponding to the signal acquisition requirement.

In some embodiments, by taking into account the similarity between the different signal acquisition devices, an acquisition device group with higher acquisition efficiency may be determined, such that signal acquisition devices in the same acquisition device group may collaborate in acquiring the gas pipeline network signal.

In some embodiments, the company management platform, based on the signal acquisition parameter of each signal acquisition device in each acquisition device group, divides the acquisition device groups according to the group through the gas company sensor network platform and the device object platform, and sends signal acquisition instructions to the corresponding signal acquisition devices in sequence. The signal acquisition instructions include the signal acquisition parameters.

It is to be understood that dividing the acquisition device group and sending the signal acquisition parameter to the corresponding signal acquisition device by the group may improve the regulation efficiency of the signal acquisition by looking up the signal acquisition devices from the acquisition device group or updating the signal acquisition parameter in units of the acquisition device group when subsequently updating the signal acquisition parameter of some of the signal acquisition devices.

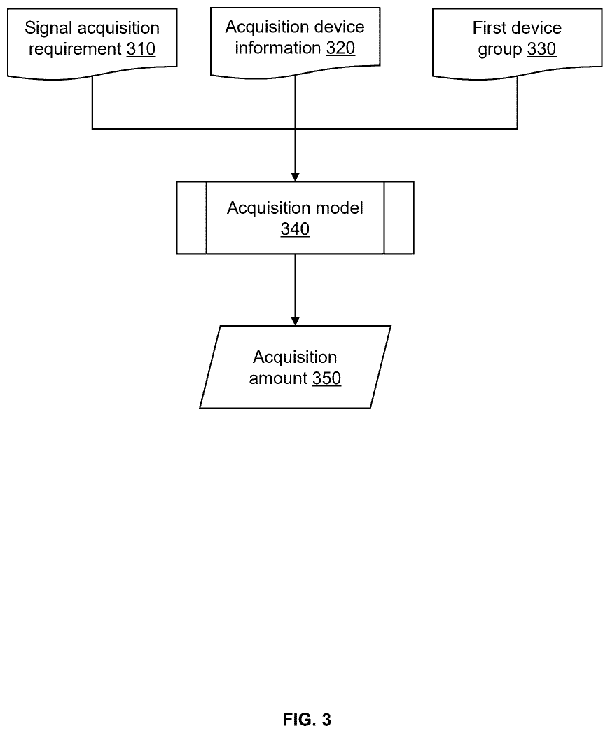

In some embodiments, the acquisition amounts of different signal acquisition devices in the same acquisition device group may be different. Descriptions regarding determining the acquisition amounts of the different signal acquisition devices may be found in FIG. 3 and its related description.

In some embodiments, by dividing the signal acquisition devices into a plurality of acquisition device groups and sending the signal acquisition parameter according to the acquisition device group, the efficiency of regulating the signal acquisition parameter can be improved, thereby improving the efficiency of acquiring the gas pipeline network signal and avoiding repeated adjustments.

In some embodiments, the company management platform may determine the acquisition amount of at least one in-group acquisition device through the acquisition model, and determine, based on an acquisition priority and the acquisition device information, the signal acquisition parameter corresponding to the at least one acquisition device group. More descriptions regarding this section may be found in FIG. 4 and the relevant descriptions.

In some embodiments, the company management platform may determine the acquisition priority based on the signal acquisition requirement, and determine the signal acquisition parameter corresponding to the at least one acquisition device group based on the acquisition priority and the acquisition device information.

The acquisition priority is used to characterize the degree of priority for different signal acquisition requirements. In some embodiments, the acquisition priority may be expressed, for example, by a numerical value, where the larger the value, the higher the acquisition priority.

In some embodiments, the company management platform may receive a plurality of signal acquisition requirements simultaneously. When the plurality of signal acquisition requirements are received, and signal acquisition is not possible for the plurality of signal acquisition requirements at the same time due to limitations in the count of the signal acquisition devices, the acquisition priority of the signal acquisition requirement may be used to determine the order of signal acquisition between the plurality of signal acquisition requirements. The company management platform tends to prioritize signal acquisition for the signal acquisition requirement with a higher acquisition priority.

In some embodiments, the company management platform may determine the acquisition priority in a plurality of ways. For example, the company management platform determines an acquisition priority corresponding to the signal acquisition requirement based on the signal acquisition requirement via a priority table.

The priority table may be predetermined by the technicians of the gas company based on historical experience. The priority table includes a plurality of signal acquisition requirements and an acquisition priority for each signal acquisition requirement. For example, the hidden danger detection requirement needs to detect the hidden danger of the gas pipeline network through the gas pipeline network signal, which is a more urgent requirement with a higher acquisition priority.

In some embodiments, the company management platform also determines the acquisition priority based on the signal acquisition requirement and the feedback information.

In some embodiments, the company management platform may determine an adjustment coefficient based on the negative information in the feedback information corresponding to the signal acquisition requirement, correct the acquisition priority determined based on the adjustment coefficient through the priority table, and obtain a new acquisition priority.

The negative information refers to one piece of feedback information indicating that the gas pipeline network needs improvement, for example, information indicating that the gas pipeline network needs to be cleaned, needs to be repaired, needs to be renovated, etc.

The feedback information refers to one piece of information that is fed back to the company management platform from the government safety monitoring and management platform, for example, pipeline network renovation information, pipeline network cleaning information, and gas outage information. In the embodiments, the pipeline network renovation information includes the gas pipeline or area that needs to be renovated. The pipeline network cleaning information includes the gas pipelines or areas that need to be cleaned. The gas outage information includes areas requiring gas outages.

In some embodiments, when the company management platform uploads the gas pipeline network signal to the government safety monitoring and management platform via the government safety monitoring sensor network platform, the government safety monitoring and management platform may analyze the gas pipeline network signal to obtain at least one analysis result and designate the at least one analysis result as the feedback information. For example, when the government safety monitoring and management platform analyzes the gas pipeline network signal and finds that the gas pipeline network has deteriorated and needs to be renovated, it sends out the pipeline network renovation information. It is to be understood that the government safety monitoring and management platform receives a plurality of gas pipeline network signals corresponding to a plurality of signal acquisition requirements, which helps to analyze and obtain a plurality of analysis results corresponding to each signal acquisition requirement, and thus the feedback information includes a plurality of sets of data, each set of data corresponding to one signal acquisition requirement.

More descriptions regarding the feedback information may be found in FIG. 4 and the relevant descriptions.

In some embodiments, for each signal acquisition requirement, the company management platform selects a set of feedback information in the feedback information that corresponds to the signal acquisition requirement of that type and counts the amount of feedback information in the set of feedback information that includes negative information. The company management platform may calculate a ratio of the foregoing count to the total count of the feedback information in the set of feedback information and add 1 to the ratio to obtain an adjustment coefficient.

In some embodiments, the company management platform designates the product of the acquisition priority determined via the priority table and the adjustment coefficient as the new acquisition priority.

In some embodiments, the company management platform determines an area location corresponding to the signal acquisition requirement with a higher acquisition priority based on the acquisition priority and the acquisition device information and determines the acquisition device group based on the plurality of preparatory groups and the area location. The company management platform determines, by querying the acquisition requirement table, the signal acquisition parameter of the signal acquisition devices within the acquisition device group, and sends, through the gas company sensor network platform and the device object platform, the signal acquisition parameter and the acquisition amount determined by the acquisition model to the corresponding signal acquisition device by the group. Descriptions regarding the preparatory groups, the acquisition requirement table, and determining the acquisition device may be found in the related description above. More descriptions regarding the acquisition model may be found in FIG. 3 and relevant descriptions

In some embodiments, the company management platform may determine the signal acquisition parameter corresponding to the at least one acquisition device group based on the acquisition priority and the second device group. The second device group includes the general device group and the special device group. More descriptions regarding the general device group and the special device group may be found in FIG. 4 and the relevant descriptions.

In some embodiments, the company management platform may determine a signal acquisition device of the second device group being the special device group as the signal acquisition device corresponding to the signal acquisition requirement with a higher acquisition priority, and set signal acquisition parameters of different time order for the signal acquisition device within the special device group according to the acquisition priority. Meanwhile, when a plurality of signal acquisition requirements are signals acquired through the signal acquisition device in the special device group, the acquisition order of the different signal acquisition requirements is determined according to the acquisition priority. For example, for a plurality of signal acquisition requirements with different acquisition priorities, the acquisition order of the signal acquisition requirement with a higher acquisition priority is higher. For a plurality of signal acquisition requirements with the same acquisition priority, the acquisition order of the signal acquisition requirement that requires a shorter acquisition time is higher.

Exemplarily, there are two signal acquisition requirements with different acquisition priorities, and two groups of signal acquisition parameters with sequential acquisition times are set up for the signal acquisition devices within the special device group, and the signal acquisition parameter with an earlier acquisition time corresponds to the signal acquisition requirement with a higher acquisition priority.

In some embodiments of the present disclosure, by determining the acquisition priority through the feedback information, the selection of the acquisition device group may be more consistent with the sequence of signal acquisition in practical applications, which ensures the signal acquisition effect. Through the general device group and the special device group, the characteristics of different signal acquisition devices may be fully considered, and the signal acquisition parameter of the signal acquisition devices in the special device group may be prioritized, to avoid affecting the normal operation of the other signal acquisition devices when adjusting the signal acquisition parameter.

In some embodiments of the present disclosure, determining the signal acquisition parameters of different acquisition device groups by the acquisition priority may improve the signal acquisition efficiency and ensure that the signal acquisition is prioritized to satisfy the more important or urgent signal acquisition requirement.

In 250, the signal acquisition parameter is sent to the device object platform through the gas company sensor network platform to control the activated acquisition device and the operating acquisition device to perform signal acquisition based on the signal acquisition parameter to obtain a gas pipeline network signal.

In some embodiments, the company management platform may send the plurality of signal acquisition parameters to the activated acquisition device and the operating acquisition device of the device object platform via the gas company sensor network platform, respectively, to control the activated acquisition device and the operating acquisition device to perform signal acquisition based on the signal acquisition parameters. In the embodiments, the operating acquisition device overrides the signal acquisition parameter over the original acquisition parameter and performs signal acquisition based on the signal acquisition parameter. The activated acquisition device performs the signal acquisition directly based on the signal acquisition parameter.

In 260, in response to an activation failure of the device to be activated, an alternative acquisition device is determined based on the acquisition device information.

The activation failure refers to the situation where the device to be activated is not successfully activated. The activation failure may occur when the device to be activated has insufficient power, the communication function fails, or the signal acquisition devices are destroyed.

In some embodiments, the company management platform may determine whether the device to be activated has failed to be activated in a plurality of ways. For example, the company management platform sends the activation instruction to the device to be activated along with a feedback instruction. If the device to be activated is successfully activated, successful activation information may be sent to the company management platform based on the feedback instruction. As another example, the company management platform determines whether the device to be activated has failed to be activated by whether it receives the gas pipeline network signal uploaded by the device to be activated. If the company management platform does not receive the gas pipeline network signal uploaded by the device to be activated, the signal acquisition devices have not been successfully activated.

In some embodiments, the company management platform may obtain a signal acquisition requirement corresponding to the acquisition device group in which the device to be activated whose activation has failed is located, and in response to the signal acquisition requirement having an acquisition priority exceeding a priority threshold, generate an updating instruction and send the updating instruction to the device maintenance personnel to update or maintain the device to be activated if activation fails, avoiding failure to meet subsequent signal acquisition requirement with a higher acquisition priority. In the embodiments, the priority threshold may be predetermined by the gas company staff. More descriptions regarding the acquisition priority may be found in FIG. 3 and the relevant descriptions.

The alternative acquisition device refers to a signal acquisition device that performs signal acquisition in place of a device to be activated whose activation has failed.

In some embodiments, the company management platform may determine the alternative acquisition device in a plurality of ways. For example, the company management platform may designate an idle acquisition device of the same model as and is closest to the device to be activated that failed to be activated as the alternative acquisition device. As another example, the company management platform may also use an idle acquisition device of the same model and on the same gas pipeline as the device to be activated that failed to be activated, as the alternative acquisition device. In the embodiments, the idle acquisition device refers to a dormant acquisition device that has not been activated.

In 270, an alternate device instruction is generated based on the alternative acquisition device and sent the alternate device instruction to the device object platform through the gas company sensor network platform to control the alternative acquisition device for signal acquisition.

The alternate device instruction refers to an instruction for controlling an alternative acquisition device for signal acquisition. In some embodiments, the alternate device instruction includes the number of the alternative acquisition device and the signal acquisition parameter.

In some embodiments, the company management platform may send the alternate device instruction to the alternative acquisition device of the device object platform via the gas company sensor network platform to control the alternative acquisition device to perform signal acquisition.

In some embodiments, by determining the device to be activated and the signal acquisition parameter based on the signal acquisition requirement, the same set of signal acquisition devices may satisfy different signal acquisition requirements, and the efficiency of signal acquisition and the utilization of signal acquisition resources are improved.

It should be noted that the foregoing description of process 200 is intended to be exemplary and illustrative only and does not limit the scope of application of the present disclosure. For a person skilled in the art, various corrections and changes can be made to process 200 under the guidance of this disclosure. However, these corrections and changes remain within the scope of this disclosure.

FIG. 3 is a schematic diagram illustrating an exemplary acquisition model according to some embodiments of the present disclosure.

In some embodiments, for at least one in-group acquisition device of the at least one acquisition device group, the company management platform determines an acquisition amount of the at least one in-group acquisition device through an acquisition model based on a signal acquisition requirement, acquisition device information, and a first device group. The in-group acquisition device refers to a signal acquisition device in the acquisition device group. The training process of the acquisition model includes determining a plurality of training data sets based on the first device group and performing an alternating training on an initial acquisition model through the plurality of training data sets. A learning rate during the alternating training is determined based on a rate of change of a difference between an output of the initial acquisition model and a label. More descriptions regarding the signal acquisition requirement, the acquisition device information, and the acquisition amount may be found in FIG. 4 and relevant descriptions.

The acquisition model refers to a model used to determine the acquisition amount. In some embodiments, the acquisition model is a machine learning model. For example, the acquisition model includes any one or a combination of recurrent neural network (RNN) models or other customized model structures.

In some embodiments, as shown in FIG. 3, inputs to the acquisition model 340 may include a signal acquisition requirement 310, acquisition device information 320, and a first device group 330, and outputs to the acquisition model 340 may include an acquisition amount 350 of the in-group acquisition device.

The first device group refers to the preparatory group to which the in-group acquisition device belongs. More descriptions regarding the preparatory group may be found in operation 240 and the relevant descriptions.

A training data set refers to a data set used to train the acquisition model. In some embodiments, the training data set may include a plurality of training samples with a label. The training samples may include sample acquisition device information for different in-group acquisition devices, a sample signal acquisition requirement, and a sample first device group. The label may be an actual acquisition amount corresponding to the in-group acquisition device. In some embodiments, the company management platform counts a plurality of historical acquisition amounts in the historical acquisition record for which the sample in-group acquisition device may meet the sample signal acquisition requirement, and designates the lowest or average value of the plurality of historical acquisition amounts as the label.

In some embodiments, the company management platform may categorize a plurality of training samples in the historical collection records based on a first device group of the sample in-group acquisition device to obtain the plurality of training data sets. Each of the training data sets corresponds to one first device group.

The alternating training refers to the operation of training the initial acquisition model alternately using different training data sets. For example, the company management platform randomly selects two training data sets from the plurality of training data sets as a set of training data sets and inputs the two training data sets within the set of training data sets into the initial acquisition model alternately to train the initial acquisition model. In the embodiments, the company management platform may produce a plurality of sets of training data sets to train the initial acquisition model.

In some embodiments, the acquisition model may be trained by alternately inputting two training data sets into the initial acquisition model, constructing a loss function from the labels and the output results of the initial acquisition model, iteratively updating the initial acquisition model based on the loss function, and replacing with the next set of training data sets for training and iteratively updating the initial acquisition model when the loss function of the initial acquisition model meets the predetermined iteration condition, then completing the acquisition model training until all the training data sets corresponding to the loss function meet the predetermined iteration condition. In the embodiments, the predetermined iteration conditions may be that the loss function converges, the count of iterations reaches a set value, etc.

In some embodiments, the company management platform may adjust the learning rate used to train the acquisition model based on an output change rate.

The output change rate is used to characterize the change in the difference between the output of the initial acquisition model and the label. In some embodiments, the company management platform counts the difference between each output of the initial acquisition model and the label, obtains a plurality of differences, and determines a plurality of output change rates by comparing the magnitude of the plurality of differences. For example, the company management platform calculates a ratio of the current difference for comparison to the previous difference and designates the ratio as the output change rate corresponding to the difference for comparison.

Exemplarily, if the magnitude of change in the output change rate is increasing for the successive predetermined count of changes, the learning rate is decreased; if the magnitude of change in the output change rate is decreasing for the successive predetermined count of changes, the learning rate is increased. In the embodiments, the predetermined count of changes may be set in advance based on historical experience. The magnitude of the decrease or increase in the learning rate is positively correlated with the magnitude of the change in the output change rate. Merely by way of example, the company management platform calculates an average of the magnitude of change in the output change rate over a consecutive predetermined count of changes, and the average is designated as the magnitude of the decrease or increase in the learning rate.

In some embodiments, the company management platform may also designate the acquisition priority of the signal acquisition requirement as an input to the acquisition model to obtain the corresponding acquisition amount for each signal acquisition device in the acquisition device group. When the inputs to the acquisition model include the acquisition priority, the training samples also include the sample acquisition priority, which corresponds to the sample signal acquisition requirement.

In some embodiments, the acquisition model may be used to quickly determine or regulate the acquisition amount of different signal acquisition devices, avoiding the problem of the poor applicability of the predetermined acquisition amount. The initial acquisition model may be alternately trained through a plurality of training data sets to obtain the acquisition model, which may improve the applicability of the model to different signal acquisition devices. The learning rate is adjusted by the rate of change of the difference between the model output and the sampling label during the training process, which may improve the efficiency of the model training.

FIG. 4 is a flowchart illustrating an exemplary process for updating a signal acquisition parameter according to some embodiments of the present disclosure. In some embodiments, process 400 is performed by a gas company management platform (hereinafter referred to as the company management platform) of an IoT system for acquiring pipeline signals for smart gas monitoring.

As shown in FIG. 4, process 400 includes the following operations.

In 410, feedback information is obtained from a government safety monitoring and management platform through a government safety monitoring sensor network platform.

More descriptions regarding the feedback information may be found in operation 240 and the relevant descriptions.

In some embodiments, the government safety monitoring and management platform may proactively send the feedback information to the company management platform. The company management platform may also send an acquisition request to the government safety monitoring and management platform via the government safety monitoring sensor network platform to obtain the feedback information determined by the government safety monitoring and management platform.

In 420, a signal coverage area of the feedback information is determined based on the feedback information.

The signal coverage area refers to an area corresponding to the feedback information where follow-up work is required. The follow-up work may include monitoring of gas pipelines, pipeline modifications, pipeline cleanups, hazard danger detection, gas outages, etc.

In some embodiments, the company management platform may determine an area where follow-up work is required based on the feedback information. For example, the company management platform may treat an area surrounded by a plurality of signal acquisition devices in the area where follow-up work is required as a signal coverage area.

In some embodiments, the government safety monitoring and management platform may send a plurality of pieces of feedback information, each of which corresponds to one signal coverage area.

In 430, a general device group and a special device group are determined based on the signal coverage area.

The general device group refers to a set of signal acquisition devices that satisfy the majority of signal acquisition requirements. For example, a set of signal acquisition devices that satisfy more than 75% of the signal acquisition requirements.

The special device group refers to a set of signal acquisition devices that satisfy a few signal acquisition requirements. For example, a set of signal acquisition devices that satisfy less than 20% of the signal acquisition requirements.

In some embodiments, the company management platform may count the percentage of times that each signal acquisition device appears in a plurality of historical signal coverage areas in the historical data, assign signal acquisition devices whose occurrence percentage exceeds the proportionality threshold to the general device group, and assign signal acquisition devices whose occurrence percentage does not exceed the proportionality threshold to the special device group. In the embodiments, the proportionality threshold may be predetermined by the gas company staff based on historical experience.

In some embodiments, the company management platform determines an overlap degree of the signal acquisition devices based on the signal coverage area, and determines the general device group and the special device group based on the overlap degree.

The overlap degree is used to characterize the ubiquity degree of the signal acquisition devices. In some embodiments, the overlap degree is expressed, for example, by a numerical value, where the larger the value, the higher the overlap degree.

In some embodiments, the company management platform may use the count of times each signal acquisition device appears in a plurality of signal coverage areas as an overlap degree of the signal acquisition device. For example, there are 10 signal coverage areas, and the signal acquisition device is present in 6 of them, the overlap degree of the signal acquisition device is 6.

In some embodiments, the company management platform may assign the signal acquisition device in the pipeline area where the overlap degree is greater than the overlap threshold to the general device group, and assign the signal acquisition device where the overlap degree is not greater than the overlap threshold to the special device group. The pipeline area refers to an area that is divided according to the type of gas pipeline, such as an area where a main pipe is located, etc. The type of the gas pipeline may be pre-set, e.g., the type of the gas pipeline includes the main pipeline, the primary branch pipeline, the secondary branch pipeline, etc.

In some embodiments, a pipeline area corresponds to an overlap threshold, and the company management platform may, based on the pipeline region, the type of historical feedback information corresponding to the pipeline region, and the count of times that the historical feedback information occurs, determine different overlap thresholds for different pipeline regions according to the overlap threshold equation. Exemplarily, the overlap threshold equation is shown in equation (3) below:

$$Y = \frac{Y 0}{x \times ( 1 + \frac{f}{100} )} \qquad ( 3 )$$

Y denotes the overlap threshold, and Y0 denotes an initial overlap threshold; x denotes the count of types of the historical feedback information; and f denotes the count of times the historical feedback information appears. It may be understood that the more the types of the historical feedback information, the more the count of occurrences of the historical feedback information, and the smaller the overlap threshold, the more the signal acquisition devices tend to be assigned to the general device group. The initial overlap threshold for the pipeline area is predetermined by the gas company staff based on historical experience.

In some embodiments, the company management platform may also determine the general device group and the special device group based on the historical acquisition records by a predetermined algorithm, and dynamically adjust the general device group and the special device group by the predetermined algorithm as the historical acquisition records are added. In the embodiments, the predetermined algorithm may be predetermined by a technician based on historical experience.

The predetermined algorithm includes the following operations.

In S41, based on the historical acquisition records, a historical signal coverage area corresponding to each historical acquisition record is determined, and the signal acquisition devices in each historical signal coverage area are designated as a device set. For example, if the signal coverage area includes a signal acquisition device 1, a signal acquisition device 2, and a signal acquisition device 3, then the three signal acquisition devices are designated as a device set.

In S42, for each device set in the plurality of device sets, a plurality of subsets of the device set are obtained based on the device set, and a ratio of the count of occurrences of the subset to the total count of device sets is taken as an incidence of the subset.

The subset refers to a set obtained by any combination of the signal acquisition devices in the device set. For example, if the device set is {the signal acquisition device 1, the signal acquisition device 2, the signal acquisition device 3}, the subset includes a set of any one of the elements of the device set {the signal acquisition device 1}, {the signal acquisition device 2}, {the signal acquisition device 3}, and also includes a set of any two elements, and a set of any three elements in the device set.

The count of occurrences of a subset refers to a count of times the subset occurs in a plurality of subsets generated from different device sets. For example, if the device set H may be obtained from the subset h, and the device set I may be obtained from the subset h, the count of times that the subset h occurs is 2.

In S43, a subset with an incidence greater than a predetermined occurrence threshold is designated as a frequent subset.

In some embodiments, the company management platform determines a predetermined occurrence threshold based on the count of the signal acquisition devices that are used less frequently and the total count of signal acquisition devices of the historical general device group. Merely by way of example, the predetermined occurrence threshold may be calculated by an equation (4):

$$P = P 0 \times ( 1 - \frac{r}{s} ) \qquad ( 4 )$$

P0 denotes an initial value of the predetermined occurrence threshold, r denotes a count of signal acquisition devices that are used less frequently, and s denotes the total count of signal acquisition devices. In this case, the signal acquisition devices that are used less frequently refer to signal acquisition devices in the historical general device group that are used less than a predetermined count threshold (e.g., 3 times, etc.). The predetermined count threshold and the initial value of the predetermined occurrence threshold are set in advance by the staff based on historical experience.

In S44, the frequent subset that contains the highest count of signal acquisition devices is designated as a general device group, and the subset that has a count of occurrences that is less than or equal to the predetermined occurrence threshold is designated as a special device group, and the rest of the subsets are designated as independent signal acquisition devices.

In 440, the device to be activated is determined based on the signal acquisition requirement, the acquisition device information, the general device group, and the special device group.

In some embodiments, when determining the device to be activated, the company management platform may prioritize a dormant acquisition device in the general device group as the device to be activated.

More descriptions regarding determining the device to be activated based on the signal acquisition requirement and the acquisition device information may be found in FIG. 2 and the relevant descriptions

In some embodiments, the company management platform may determine at least one classification group based on the acquisition device information, classify the device to be activated with the activation failure into at least one device group to be processed based on a classification group to which the device to be activated with the activation failure belongs, and generate an updating instruction based on the at least one device group to be processed, to update or maintain the device to be activated with the activation failure.

The classification group refers to a group to which the signal acquisition device is classified. The signal acquisition devices in each classification group are of the same or similar model, location, and importance level. More descriptions regarding the importance level may be found in operation 240 and the relevant descriptions.

In some embodiments, the company management platform may designate signal acquisition devices that are located in the same pipeline area, of similar importance level, and of the same or similar model as a classification group. The signal acquisition devices of the same or similar model refer to signal acquisition devices that acquire the same type of gas pipeline signal.

The device group to be processed refers to a combination consisting of signal acquisition devices that are required to be processed for updating or maintenance, etc.

In some embodiments, the company management platform may classify the device to be activated with the activation failure in the same classification group into a device group to be processed. One classification group corresponds to one device group to be processed.

The updating instruction refers to an instruction that directs an update or maintenance of the signal acquisition devices in the device group to be processed. In some embodiments, the updating instruction includes an update maintenance time for the device group to be processed, etc.

In some embodiments, the company management platform generates the updating instruction based on the importance value of the device group to be processed. For example, the company management platform may set the update maintenance time for the device group to be processed with a higher importance value at an earlier time.

In some embodiments, the company management platform determines an important value of the device group to be processed based on the overlap degree of the signal acquisition devices within the device group to be processed and the acquisition priority, and the higher the overlap degree, the higher the acquisition priority, and the higher the important value. Merely by way of example, the important value of the device group to be processed may be the sum of an average value of the overlap degree and an average value of the acquisition priority of the plurality of signal acquisition devices within the device group to be processed. More descriptions regarding the acquisition priority may be found in FIG. 2 and the relevant descriptions.

In some embodiments, the company management platform may send the updating instruction to a maintenance person to update or maintain the signal acquisition devices within the device group to be processed.

In some embodiments, by dividing different device groups to be processed according to the characteristics of the signal acquisition devices and determining the processing order of the device groups to be processed by the importance value of the device groups to be processed, a priority may be given to updating or maintaining the more important or more urgent device groups to be processed.

In 450, a signal acquisition parameter corresponding to the general device group is updated.

In some embodiments, the company management platform determines a plurality of signal acquisition requirements corresponding to the general device group based on the signal acquisition requirement via the acquisition requirement table and updates the signal acquisition parameter corresponding to the general device group based on the plurality of signal acquisition requirements. For example, the company management platform determines a plurality of acquisition amounts based on the plurality of signal acquisition requirements via an acquisition model and designates the maximum value of the acquisition amounts as the acquisition amount of the signal acquisition devices within the general device group.

As another example, the company management platform determines a plurality of signal acquisition parameters corresponding to the plurality of signal acquisition requirements through the acquisition requirement table, selects the acquisition time with the longest duration among the plurality of signal acquisition parameters, and selects the shortest acquisition period among the plurality of signal acquisition parameters as the acquisition time and acquisition period of the signal acquisition devices within the general device group. Descriptions regarding the acquisition model may be found in FIG. 3 and related descriptions, and descriptions regarding the acquisition requirement table may be found in FIG. 2 and its related descriptions.

In some embodiments of the present disclosure, by determining the general device group and the special device group, it is possible to effectively differentiate the roles played by different signal acquisition devices in the signal acquisition process, and by regulating the signal acquisition parameter of the general device group and the special device group respectively, a reasonable hardware guarantee is provided for fully meeting different signal acquisition requirements. At the same time, only setting a set of signal acquisition parameters for the general device group may satisfy the needs of a plurality of signal acquisition requirements, which further improves the regulation efficiency of signal acquisition.

Some embodiments of the present disclosure further provide a non-transitory computer-readable storage medium storing computer instructions. When the computer reads the computer instructions in the storage medium, the computer executes the method described in any of the above embodiments.

In addition, certain features, structures, or characteristics of one or more embodiments of the present disclosure may be suitably combined.

In some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

In the event of any inconsistency or conflict between the descriptions, definitions, and/or the use of terms in the materials cited in this disclosure and what is stated in this disclosure, the descriptions, definitions, and/or the use of terms in this disclosure shall prevail.

What is claimed is:

1. A method for acquiring pipeline signals for smart gas monitoring, the method being executed by a gas company management platform of an Internet of Things (IoT) system for acquiring pipeline signals for smart gas monitoring, the method comprising:
obtaining acquisition device information of a plurality of signal acquisition devices in a gas pipeline network, wherein the plurality of signal acquisition devices include a dormant acquisition device and an operating acquisition device;
determining a device to be activated based on a signal acquisition requirement and the acquisition device information;
generating an activation instruction based on the device to be activated and sending the activation instruction to a device object platform through a gas company sensor network platform to activate the device to be activated to obtain an activated acquisition device;
determining a signal acquisition parameter based on the signal acquisition requirement;
sending the signal acquisition parameter to the device object platform through the gas company sensor network platform to control the activated acquisition device and the operating acquisition device to perform signal acquisition based on the signal acquisition parameter to obtain a gas pipeline network signal;
in response to an activation failure of the device to be activated, determining an alternative acquisition device based on the acquisition device information; and
generating an alternate device instruction based on the alternative acquisition device and sending the alternate device instruction to the device object platform through the gas company sensor network platform to control the alternative acquisition device for signal acquisition.

2. The method of claim 1, wherein the determining a signal acquisition parameter based on the signal acquisition requirement includes:
determining at least one acquisition device group based on the acquisition device information, the signal acquisition requirement, the activated acquisition device, and the operating acquisition device; and
determining a signal acquisition parameter corresponding to the at least one acquisition device group based on the signal acquisition requirement and the acquisition device information.

3. The method of claim 2, wherein the determining at least one acquisition device group based on the acquisition device information, the signal acquisition requirement, the activated acquisition device, and the operating acquisition device includes:
determining a similarity between plurality of signal acquisition devices based on the acquisition device information and historical feedback information; and
determining the at least one acquisition device group based on the similarity and the signal acquisition requirement.

4. The method of claim 2, wherein the signal acquisition parameter includes an acquisition amount, the determining a signal acquisition parameter corresponding to the at least one acquisition device group based on the signal acquisition requirement and the acquisition device information includes:
for at least one in-group acquisition device of the at least one acquisition device group, determining an acquisition amount of the at least one in-group acquisition device through an acquisition model based on the signal acquisition requirement, the acquisition device information, and a first device group, and the acquisition model being a machine learning model; and
a training process of the acquisition model including:
determining a plurality of training data sets based on the first device group; and
performing an alternating training on an initial acquisition model through the plurality of training data sets, wherein a learning rate during the alternating training is determined based on a rate of change of a difference between an output of the initial acquisition model and a label.

5. The method of claim 2, wherein the determining a signal acquisition parameter corresponding to the at least one acquisition device group based on the signal acquisition requirement and the acquisition device information includes:
determining an acquisition priority based on the signal acquisition requirement; and
determining the signal acquisition parameter corresponding to the at least one acquisition device group based on the acquisition priority and the acquisition device information.

6. The method of claim 5, further comprising:
determining the acquisition priority based on the signal acquisition requirement and feedback information; and
determining the signal acquisition parameter corresponding to the at least one acquisition device group based on the acquisition priority and a second device group.

7. The method of claim 1, further comprising:
obtaining feedback information from a government safety monitoring and management platform through a government safety monitoring sensor network platform;
determining a signal coverage area of the feedback information based on the feedback information;
determining a general device group and a special device group based on the signal coverage area;
determining the device to be activated based on the signal acquisition requirement, the acquisition device information, the general device group, and the special device group; and
updating a signal acquisition parameter corresponding to the general device group.

8. The method of claim 7, further comprising:
determining at least one classification group based on the acquisition device information;
classifying the device to be activated with an activation failure into at least one device group to be processed based on a classification group to which the device to be activated with the activation failure belongs; and
generating an updating instruction based on the at least one device group to be processed, to update or maintain the device to be activated with the activation failure.

9. The method of claim 7, wherein the determining a general device group and a special device group based on the signal coverage area includes:
determining an overlap degree of the plurality of signal acquisition devices based on the signal coverage area; and
determining the general device group and the special device group based on the overlap degree.

10. An Internet of Things (IoT) system for acquiring pipeline signals for smart gas monitoring, comprising a government safety monitoring and management platform, a government safety monitoring sensor network platform, a government safety monitoring object platform, a gas company sensor network platform, and a device object platform, wherein the government safety monitoring object platform includes a gas company management platform;
the gas company management platform is configured on a server of a gas company, the gas company sensor network platform includes a plurality of distributed communication devices, the device object platform is communicatively connected to a plurality of signal acquisition devices, the government safety monitoring sensor network platform and the government safety monitoring and management platform are configured on a server of a government monitoring department;
the gas company management platform is configured to:
obtain acquisition device information of the plurality of signal acquisition devices in a gas pipeline network, wherein the plurality of signal acquisition devices include a dormant acquisition device and an operating acquisition device;
determine a device to be activated based on a signal acquisition requirement and the acquisition device information;
generate an activation instruction based on the device to be activated and send the activation instruction to the device object platform through the gas company sensor network platform to activate the device to be activated to obtain an activated acquisition device;
determine a signal acquisition parameter based on the signal acquisition requirement;
send the signal acquisition parameter to the device object platform through the gas company sensor network platform to control the activated acquisition device and the operating acquisition device to perform signal acquisition based on the signal acquisition parameter to obtain a gas pipeline network signal;
in response to an activation failure of the device to be activated, determine an alternative acquisition device based on the acquisition device information; and
generate an alternate device instruction based on the alternative acquisition device and send the alternate device instruction to the device object platform through the gas company sensor network platform to control the alternative acquisition device for signal acquisition.

11. The IoT system of claim 10, wherein the gas company management platform is further configured to:
determine at least one acquisition device group based on the acquisition device information, the signal acquisition requirement, the activated acquisition device, and the operating acquisition device; and
determine a signal acquisition parameter corresponding to the at least one acquisition device group based on the signal acquisition requirement and the acquisition device information.

12. The IoT system of claim 11, wherein the gas company management platform is further configured to:
determine a similarity between the plurality of signal acquisition devices based on the acquisition device information and historical feedback information; and
determine the at least one acquisition device group based on the similarity and the signal acquisition requirement.

13. The IoT system of claim 11, wherein the signal acquisition parameter includes an acquisition amount, and the gas company management platform is further configured to:
for at least one in-group acquisition device of the at least one acquisition device group, determine an acquisition amount of the at least one in-group acquisition device through an acquisition model based on the signal acquisition requirement, the acquisition device information, and a first device group, wherein the acquisition model is a machine learning model; and
a training process of the acquisition model including:
determine a plurality of training data sets based on the first device group; and
performing an alternating training on an initial acquisition model through the plurality of training data sets, wherein a learning rate during the alternating training is determined based on a rate of change of a difference between an output of the initial acquisition model and a label.

14. The IoT system of claim 11, wherein the gas company management platform is further configured to:
determine an acquisition priority based on the signal acquisition requirement; and
determine the signal acquisition parameter corresponding to the at least one acquisition device group based on the acquisition priority and the acquisition device information.

15. The IoT system of claim 14, wherein the gas company management platform is further configured to:
determine the acquisition priority based on the signal acquisition requirement and feedback information; and
determining the signal acquisition parameter corresponding to the at least one acquisition device group based on the acquisition priority and a second device group.

16. The IoT system of claim 10, wherein the gas company management platform is further configured to:
obtain the feedback information from the government safety monitoring and management platform through the government safety monitoring sensor network platform;
determine a signal coverage area of the feedback information based on the feedback information;
determine a general device group and a special device group based on the signal coverage area;
determine the device to be activated based on the signal acquisition requirement, the acquisition device information, the general device group, and the special device group; and
update a signal acquisition parameter corresponding to the general device group.

17. The IoT system of claim 16, wherein the gas company management platform is further configured to:
determine at least one classification group based on the acquisition device information;
classify the device to be activated with an activation failure into at least one device group to be processed based on a classification group to which the device to be activated with the activation failure belongs; and
generate an updating instruction based on the at least one device group to be processed and send the updating instruction to the device object platform through the gas company sensor network platform.

18. The IoT system of claim 16, wherein the gas company management platform is further configured to:
determine an overlap degree of the plurality of signal acquisition devices based on the signal coverage area; and
determine the general device group and the special device group based on the overlap degree.

19. A non-transitory computer-readable storage medium storing computer instructions, wherein when a computer reads the computer instructions in the storage medium, the computer implements the method of claim 1.
